(19) United States
(12) Patent Application Publication
(10) Pub. No.: US 2018/0199242 A1
(43) Pub. Date: Jul. 12, 2018

(54) METHOD AND APPARATUS FOR SECONDARY NODE CHANGE AND BASE STATION

(71) Applicant: SPREADTRUM COMMUNICATIONS (SHANGHAI) CO., LTD., Zhangjiang Shanghai (CN)

(72) Inventor: Yun DENG, Zhangjiang Shanghai (CN)

(21) Appl. No.: 15/842,067

(22) Filed: Dec. 14, 2017

(30) Foreign Application Priority Data
Jan. 6, 2017 (CN) 201710010702.1

(51) Int. Cl. H04W 36/00; H04W 36/30; H04W 36/38

(52) U.S. Cl. CPC H04W 36/0022; H04W 36/30; H04W 36/38; H04W 36/0088; H04W 76/026; H04W 36/0038

(57) ABSTRACT

A method and apparatus for changing secondary node and base station is provided, the method comprises: receiving a measurement report of at least one frequency a user equipment does for, the user equipment is in a dual connected state, a system corresponding to the at least one frequency is different from a system to which a master node belongs; determining whether to change a secondary node, according to the measurement report of the at least one frequency. By this method, the secondary node changing under the dual connectivity state established by evolved node base stations belonging to different system can be optimized and the data transmission efficiency can be improved.

### CROSS-REFERENCE TO RELATED APPLICATIONS

The present invention claims priority under 35 U.S.C. §119 to Chinese Patent Application No. 201710010702.1, filed on Jan. 6, 2017, the entire disclosure of which is incorporated herein by reference.

### TECHNICAL FIELD

The present disclosure generally relates to communication technology field, and more particularly, to a method and an apparatus for secondary node change and base station.

### BACKGROUND

For an user equipment (UE) in a connected state, if there is a service requirement, a E-UTRAN NodeB (eNB) can configure carrier aggregation (CA) for the UE. During carrier aggregation, the UE can simultaneously use resources of multiple component carriers to achieve high speed data transmission rate. Typically, component carriers which carry out carrier aggregation, are located at a same evolved base station.

A dual connectivity is introduced to a Long Term Evolution (LTE) system. FIG. 1 is a schematic diagram of a dual connectivity usage scenario according to an existing technology. Referring to FIG. 1, the UE can simultaneously transmit/receive data using the time-frequency resources of eNB1 and eNB2, which can improve data throughput rate, and also improve a mobility performance of the UE. For UE configured with dual-connectivity, a master node(MN or Master eNB, MeNB) connected to it is responsible for the transmission of a Radio Resource Control (RRC) signaling, such as the eNB1 in FIG. 1. A secondary node (SN or Secondary eNB, SeNB) is responsible for the configuration of a secondary cell group (SCG), such as the eNB2 in FIG. 1, the secondary cells configured by the secondary node needs to be sent to the UE by the RRC signaling through the master node. Both the master node and the secondary node may configure multiple serving cells to the UE. Movement of the UE can lead to a change of the secondary node, and the master node needs to determine whether to re-configure a secondary node according to measurement reports from the UE. For example, if current secondary cell is Cell2, as the UE moves, a new secondary cell is Cell3, and Cell2 and Cell3 belong to different eNBs. During this process, the master node dominates this modification of the secondary node.

In a new wireless technology such as the fifth generation mobile communication technology (5-Generation, 5G) system and the like, since a new radio (New Radio, NR) starts to cover as a hot spot only at first, therefore, when 5G radio resources to transmit data is required, the UE needs to support a dual connectivity of the LTE and the NR. For example, the UE connects with the eNB of the LTE at first, in a connected state, and if a high-speed data transmission is needed, an available NR cell can be configured for the UE by the eNB of the LTE, so that the UE can be in a dual-connectivity state of a LTE and NR, which thus can make a full use of radio resources of the LTE and NR. The NR and LTE belong to different systems, therefore, when the NR works as a secondary node (SN), it needs to have partial control function, such as to generate a signaling to configure parameters for the UE from the NR side.

However, the movement of the UE may make the UE to move from the current NR cell to a neighboring NR cell, and if it is still necessary for the master node of LTE to determine whether to change the secondary node (i.e. NR base station), the master node needs to obtain information such as load information of a target NR cell, cell interference information etc., to make an appropriate decision. However, as the LTE and NR belong to different systems, the master node of the LTE don't know well of the load information, the interference information etc., of the NR cell, which can affect change of the secondary node, and further affect the data transmission efficiency between the UE and the eNB.

### SUMMARY

Embodiments of the present disclosure provide a solution to optimize change of secondary node in a dual-connectivity state established by base stations belonging to different systems, and to improve data transmission efficiency.

A method for secondary node change is provided, applied in a secondary node, including: receiving a measurement report of at least one frequency of a user equipment, the user equipment being in a dual connectivity state, a system corresponding to the at least one frequency being different from a system to which a master node belongs; determining whether to change a secondary node, according to the measurement report of the at least one frequency.

Optionally, wherein determining whether to change a secondary node, according to the measurement report of the at least one frequency, may include: determining whether to change the secondary node, according to the measurement report of the at least one frequency, and cell load information of cells included in the measurement report.

Optionally, the method may further include: transmitting a secondary node change request to a target secondary node, when determining to change the current secondary node, so that the target secondary node determines whether to accept the secondary node change request or not, based on the cell load information, after receiving the secondary node change request.

Optionally, the method may further include: generating a new security key to use for the target secondary node, according to the current security key of SCG bearer, when determining to change the secondary node, if the user equipment is configured with the SCG bearer; transmitting the new security key together within the secondary node change request.

Optionally, the method may further include: transmitting a handover signaling to the user equipment, after receiving a secondary node change response transmitted by the target secondary node, so that the user equipment accesses the target secondary node according to the handover signaling.

Optionally, the target secondary node may send a first notification to a core network, so that the core network changes a transport path of the SCG bearer to the target secondary node.

Optionally, wherein after the user equipment accesses the target secondary node, the target secondary node may transmit a second notification to the master node, so that the master node learns information of the target secondary node.

Optionally, the method may further include: transmitting a third notification to the master node, after receiving the secondary node change response transmitted by the target secondary node, so that the master node learns information of the target secondary node.

Optionally, wherein if the user equipment is configured with a split bearer, the master node may establish a transmission channel between the master node and the target secondary node, after the master node learns information of the target secondary node, to transmit a split bearer data.

Optionally, wherein the secondary node change request may include: SCG bearer and/or split bearer information of the user equipment.

Optionally, wherein receiving a measurement report of at least one frequency of a user equipment, may include: receiving the measurement report of at least one frequency of a user equipment from the master node or the user equipment, wherein, the measurement report of the at least one frequency is generated by the user equipment according to measurement configuration from the secondary node.

An apparatus for secondary node change is provided, applied in a secondary node, including: a measurement report receiving circuitry, may be configured to receive a measurement report of at least one frequency a user equipment does for, the user equipment being in a dual connectivity, a system corresponding to the at least one frequency being different from a system to which a master node belongs; a changing circuitry, may be configured to determine whether to change a secondary node, according to the measurement report of the at least one frequency.

Optionally, wherein the changing circuitry, may be configured to: determine whether to change the secondary evolved node base station, according to the measurement report of the at least one frequency, and a cell load information of the cells included in the measurement report.

Optionally, the apparatus may further include: a secondary node change request transmitting circuitry, configured to: transmit a secondary node change request to a target secondary node, when determining to switch a current secondary node, so that the target secondary node determines whether to accept the secondary node change request or not, based on the cell load information after receiving the secondary node change request.

Optionally, the apparatus may further include: a key generating circuitry, configured to generate a new security key to use for the target secondary node, according to a current security key of a SCG bearer when determining to switch the secondary node, if the user equipment is configured with the SCG bearer; a key transmitting circuitry, configured to transmit the new security key together within the secondary node change request.

Optionally, the apparatus may further include: a handover signaling transmitting circuitry, configured to transmit a handover signaling to the user equipment, after receiving a secondary node changing response transmitted by the target secondary node, so that the user equipment accesses the target secondary node according to the handover signaling.

Optionally, wherein if the user equipment is configured with a SCG bearer, the target secondary node may send a first notification to a core network, so that the core network changes a transport path of the SCG bearer to the target secondary node.

Optionally, wherein after the user equipment accesses the target secondary node, the target secondary node may transmit a second notification to the master node, so that the master node learns information of the target secondary node.

Optionally, the apparatus may further include: a notification transmitting circuitry, configured to transmit a third notification to the master node, after receiving the secondary node changing response transmitted by the target secondary node, so that the master node learns information of the target secondary node.

Optionally, wherein if the user equipment is configured with a split bearer, the master node may establish a transmission channel between the master node and the target secondary node, after the master node learns information of the target secondary node, to transmit a split bearer data.

Optionally, wherein the secondary node change request may include: split bearer and/or SCG bearer information of the user equipment.

Optionally, wherein the measurement report receiving circuitry, may be configured to: receive the measurement report of at least one frequency of a user equipment from the master node or the user equipment, wherein, the measurement report of the at least one frequency is generated by the user equipment according to measurement configuration from the secondary node.

An evolved node base station is provided, including an apparatus for changing secondary node recited above.

Embodiments of the present disclosure may provide following advantages.

Embodiments of the present disclosure receives a measurement report of at least one frequency from a user equipment, the user equipment is in a dual-connectivity state. A system corresponding to the at least one frequency (that is, the system corresponding to a cell on the frequency), is different from a system the master node belongs to. A secondary node determines whether to switch the current secondary node, according to the measurement report of the at least one frequency.

Compared with the existing technology where the master node determines whether to switch the secondary node, in embodiments of this present disclosure, the system corresponding to the at least one frequency is different from the system to which the master node belongs, and the secondary node receives the measurement report for at least one frequency from the user equipment, and determines whether to switch the current secondary node. Therefore, an optimization of the secondary node changing under the dual connectivity state established by evolved node base stations belonging to different systems can be realized. A better evolved node base station can be selected to provide service for the user equipment, which can improve the data transmission efficiency, and avoid improper secondary node switch resulted from the master node misunderstanding of the information of the secondary node in different system.

Further, after the user equipment accesses the target secondary node, the target secondary node transmits a second notification to the master node, so that the master node learns information of the target secondary node; or, after receiving the secondary node changing response transmitted by the target secondary node, the target secondary node transmits a third notification to the master node, so that the master node learns information of the target secondary node. In embodiments of this disclosure, a notification to the master node can be sent through the target secondary node or the secondary node before changing, so that the master node learns the information of the target secondary node, and by optimizing the signaling interaction in the secondary node changing process, the data transmission efficiency can be improved.

### BRIEF DESCRIPTION OF THE DRAWINGS

FIG. 1 schematically illustrates an application scenario of a dual connectivity according to the existing technology;

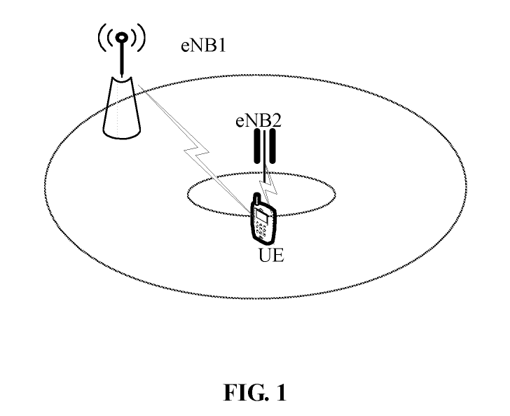

FIG. 2 schematically illustrates a data flow chart of a dual connectivity establishment process according to the existing technology;

FIG. 3 schematically illustrates a flow chart of a method for secondary node changing according to an embodiment;

FIG. 4 schematically illustrates a data flow chart of a method for secondary node changing according to an embodiment;

FIG. 5 schematically illustrates a structural diagram chart of an apparatus for secondary node changing according to an embodiment; and

FIG. 6 schematically illustrates a structural diagram chart of an apparatus for secondary node changing according to another embodiment.

### DETAILED DESCRIPTION

As described in the background, movement of a UE can lead to the UE move from a current secondary node to a neighboring secondary node, if it is still necessary for the master node of LTE to determine whether to switch the secondary node, the master node needs to be able to obtain information such as a load information of a target NR cell, cell interference information and the like, to make a reasonable decision, but as the LTE and NR belong to different systems, the master node of the LTE can't understand the load information, the interference information and the like of the NR side cell well, which can affects changing of the secondary node, and further affects the data transmission efficiency between the UE and the evolved node base station.

Applicant of this present disclosure analyzed the existing technology: when the evolved node base stations of two different systems configure a dual connected state for the user equipment, if the UE accesses the LTE first, then the master node belongs to the LTE system, and the secondary node belongs to the NR system, hereby we take the LTE and NR systems to establish a dual connectivity as an example, but embodiments of this disclosure are not just limited to be only a scenario of these two systems (LTE system and NR system) establish a dual connectivity. The master node needs to configure one or more carriers in the secondary node for the UE. In the initial configuration, the UE measures one or more cells of the secondary node according to a LTE measurement configuration. Then the master node configures a specific NR cell for the UE according to the measurement result of the UE, and constitutes a dual connectivity. After the dual connectivity is established successfully, since the NR can have multiple cells to serve the UE through the carrier aggregation, the secondary node needs to maintain the cell serving the UE in the NR.

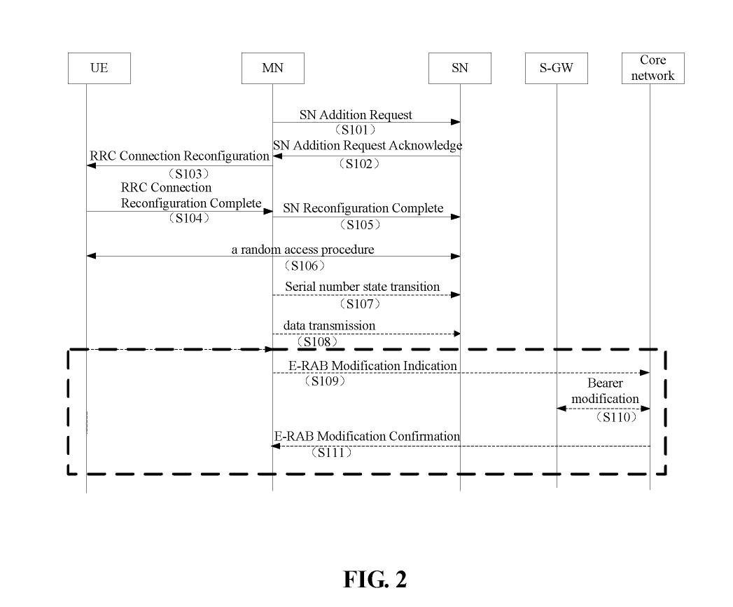

Specifically, the dual connectivity establishment process may be referred to FIG. 2, which is a schematic diagram of a data flow chart of a dual connectivity establishment process in the existing technology. Wherein, the UE has already accessed to the master node, and the UE is in the connected state, the master node can configure the dual connectivity for the user equipment according to the load status, the service requirement and the measurement report of the UE and the like, that is, adding the secondary node to the UE. The dual connectivity establishment process may include the following steps:

S101: a master node (MN) sends a secondary node addition request (SN Addition Request) to a secondary node (SN), and wherein the secondary node addition request carries a secondary cell group configuration information (SCG-ConfigInfo), which is used for configuring the secondary cell group.

The secondary cell group may include one or more cells. Specifically, the master node determines to request the secondary node to allocate a radio resource for a particular evolved radio access bearer (E-RAB), and at the same time to indicate an E-RAB characteristic (i.e., an E-RAB parameter). In addition, the master node indicates a master cell group (MCG) configuration and capability of the UE in the request, to serve as a basis for configuration of the secondary node, but the SCG configuration is not included. The master node may also provide the latest measurement results for the SCG cell to which the request is added. The secondary node may reject the request.

S102: the secondary node transmits an addition request acknowledgment information (SN Addition Request Acknowledge) including the SCG cell configuration information to the master node, when receiving the secondary node addition request from the master node.

Specifically, if the Radio Resource Management (RRM) entity in the secondary node is able to accept the resource request, a corresponding radio resource is assigned thereto. Assigning a corresponding transmission network resource according to a bearer option is also available. The secondary node provides a SCG cell configuration information to the master node. Wherein, in the case where a split bearer exists, the transmission of the user plane data can be performed after step S102. In the case of an SCG bearer (also referred to as a transport bearer) exists, a data retransmission and a sequence number status transfer may be performed after step S102.

S103: the master node sends a RRC Connection Reconfiguration Signaling (RRC Connection Reconfiguration) to the UE. The reconfiguration signaling contains a configuration information of the SCG cell.

S104: the UE sends a RRC Connection Reconfiguration Complete Signaling (RRC Connection Reconfiguration Complete) to the master node.

S105: the master node transmits the Reconfiguration Complete signaling (SN Reconfiguration Complete) of the UE to the secondary node.

S106: the UE initiates a random access procedure to the secondary node.

Wherein, steps S104 and S106 may be performed in parallel.

S107˜S108: when a SCG Bearer is configured, the master node can take a corresponding action according to a different evolved radio access bearer (E-RAB) attributes, to mitigate a service interruption due to a dual connectivity activation.

S109˜S111: in the SCG-Bearer scenario, the master node informs a core network to update a bearer information of the E-RAB, such as an user plane path. Specifically, the above process may include: the master node sends an information of a E-RAB Modification Indication to the Mobility Management Entity (MME); the MME sends an information of a Bearer Modification to a service gateway (Serving Gate Way, S-GW); finally, the MME sends a E-RAB modification confirmation message to the master node.

Therefore, by all the above processes, dual connectivity state of the UE has been established. When evolved node base stations of two different systems configure the dual connectivity state for the UE, because passing the information of different systems between the LTE and NR system can lead to the two systems (the LTE system and the NR system) have a very high degree of coupling, which is not conducive to a separate evolution of the agreement, therefore embodiments of this disclosure proposes a new mobility strategy, which is the secondary node of the dual connectivity makes a mobility decision for the secondary node side.

In order to make those skilled in the art to better understand objects, figures and advantages of this disclosure, detailed description about a specific embodiment of this disclosure can be done in conjunction with an accompanying figure.

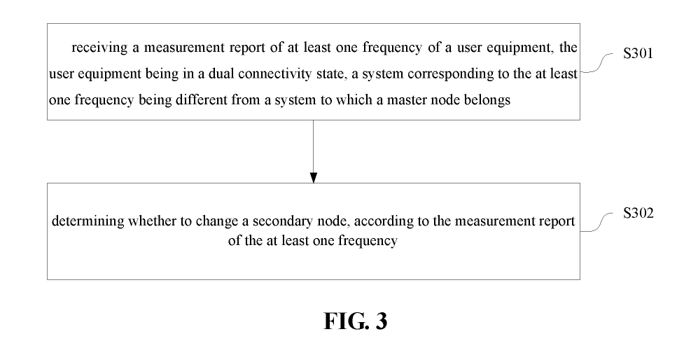

FIG. 3 schematically illustrates a flow chart of a secondary node changing method according to an embodiment.

The secondary node changing method shown in FIG. 3 may include the following steps:

S301: receiving a measurement report of at least one frequency of a user equipment, the user equipment being in a dual connectivity state, a system corresponding to the at least one frequency (that is, the system corresponding to the cell on the frequency) being different from a system to which a master node belongs. Here master node and secondary node belong to different systems.

S302: determining whether to switch a secondary node, according to the measurement report of the at least one frequency.

In this embodiment, the secondary node changing method can be performed at the secondary node side, and the secondary node is the secondary node when a dual connectivity of evolved node base stations of different systems is established.

In some embodiments, the UE is in the dual connectivity state refers to the UE is in a dual connectivity state which connects two communication systems. Specifically, the two communication systems may be a LTE system and a NR system. Then, the master node may belong to the LTE system, and accordingly, the secondary node belongs to the NR system; or the master node may belong to the NR system, and accordingly, the secondary node belongs to the LTE system. The UE can determine which system belongs to based on the parameter information of the cell.

In some embodiment, if the system corresponding to the at least one frequency measured by the UE belongs to a different system with the master node, then in step S301, the secondary node may be the evolved node base station which receives the measurement report of the at least one frequency the UE does for. Specifically, the secondary node may configure measurements for certain frequencies in the system where the secondary node is located for the user equipment, for example, to configure a measurement for the frequency of a NR cell at which the UE is currently accessing.

It is understandable that, the measurement report may include an object measured by the user equipment, a cell list, a measurement result, and the like.

Preferably, step S301 may include the following steps: receiving the measurement report of at least one frequency an UE does for from the master node or the UE. In other words, the UE may send the measurement report of the at least one frequency to the secondary node directly; or the UE may send the measurement report of the at least one frequency to the master node, and then forward to the secondary node by the master node. Specifically, the master node may determine that the at least one frequency belongs to the system where the secondary node is located, so that may forward the measurement report of the at least one frequency to the secondary node.

In some embodiments, after the secondary node obtains the measurement report of the at least one frequency in step S301, and in step S302, the secondary node can determine whether to switch a secondary node, according to the measurement report of the at least one frequency. That is, when the secondary node evaluates according to the measurement report, and a cell having a better signal exists at the frequency, then the secondary node can determine to use the evolved node base station corresponding to the cell as a target secondary node, and determine to switch so that can provide a better wireless service for the UE.

Compared with the master node determines whether to switch the secondary node recited in the existing technology, embodiments in this present disclosure, where the system corresponding to the at least one frequency is different from the system to which the master node belongs, the secondary node receives the measurement report for at least one frequency from the user equipment, and determines whether to switch the current secondary node, therefore can optimize the secondary node changing under the dual connectivity state established by evolved node base stations belonging to different systems, and can select a better evolved node base station to provide service for the user equipment, thereby can improve the data transmission efficiency, and can avoid improper secondary node switch resulted from the master node understands the information of the secondary node in different system improperly.

Preferably, the step S302 can include the following steps: determining whether to switch the secondary node, according to the measurement report of the at least one frequency, and a cell load information of the cells included in the measurement report. In other words, the secondary node can evaluate the cell in the measurement report based on the measurement report and the cell load information, and determine whether changing the secondary node or not according to the evaluation result. In this embodiment, the secondary node currently serves the UE can obtain its cell load information from the target secondary node, since the cell load information is received and understood by the secondary station of the same system, thus the cell load information is not understood wrongly, which is conducive to a changing decision of the secondary node.

Preferably, the following steps can be included after the step S302: transmitting a secondary node change request to a target secondary node, when determining to switch a current secondary node, to make the target secondary node determines whether to accept the secondary node change request or not, based on the cell load information after receiving the secondary node change request. In other words, the secondary node can still transmit the secondary node switch request, after determining to switch the secondary node; the target secondary station can determine whether to accept the switch according to the secondary node switch request and its current cell load information.

Preferably, the secondary node change request can include a split bearer and/or a SCG bearer information of the user equipment.

Further, the following step can be included after the step S302: generating a new security key to use for the target secondary node, according to a current security key of a SCG bearer, when determining to switch the secondary node, if the user equipment is configured with the SCG bearer, for example, can generate a new security key by the mechanism defined in a security protocol, and the current security key may be used as an input parameter when generating the new security key, and other input parameters may be added; and when the secondary node change request is transmitted, the new key can be transmitted simultaneously. Specifically, since the secondary node change request may include split bearer and/or SCG bearer information of the UE, and to the SCG bearer (Switched Bearer or SCG Bearer), the transmission of its data is performed entirely by the secondary node, its packet data convergence protocol (PDCP) entity is located in the secondary node, therefore, when the UE is configured with the SCG bearer, the secondary node can derive the new security key applied to the target secondary node, based on the security key currently applied to the SCG bearer. And the derived new key can be carried in the secondary node change request.

Further, the target secondary node sends a first notification to a core network, if the user equipment is configured with a SCG bearer, so that the core network switches a transport path of the SCG bearer to the target secondary node, and so that the core network transmits a downlink data of the SCG bearer to the target secondary node directly.

Preferably, after step S302, the following steps may be included: transmitting a handover signaling to the UE, after determining to switch the secondary node, that is also after receiving a secondary node changing response transmitted by the target secondary node, so that the user equipment accesses the target secondary node according to the handover signaling. In other words, the target secondary node can transmit a secondary node change response signaling to the secondary node, after receiving the secondary node change request, the secondary node in the dual connectivity state can transmit a handover signaling to the user equipment; at this time, the user equipment can access to the target secondary node, and keep it in synchronous.

Further, the target secondary node transmits a second notification to the master node, after the user equipment accesses the target secondary node, so that the master node learns information of the target secondary node.

Preferably, when the secondary node determines to switch, the secondary node transmits a third notification to the master node, so that the master node learns information of the target secondary node. In other words, once the secondary node is informed that the target secondary node has received a secondary node change request, then the secondary node can inform the information of the target secondary node to the master node.

Preferably, since the secondary node change request may include split bearer and/or SCG bearer information of the UE, if the UE has a split bearer, then after the master node learns the information of the target secondary station, a transmission channel is established between the master node and the target secondary node, for transmitting the split bearer data. Specifically, for the split bearer, using the transmission resources of the master node and the secondary node at the same time is necessary; thus, when the master node learns the information of the target secondary node, a transmission channel between the master node and the target secondary node for transmitting part split bearer data can be established, so that the master node can transmit the different split bearer data to the target secondary node, and then transmitted to the UE by the target secondary station. For the uplink data, the target secondary node needs to transmit the data to the master node through the transmission channel, after receiving the data from the UE, and the master node decrypts and sorts the data, in conjunction with the received split bearer data from the UE, then sends it to the core network.

Preferably, if the UE is configured with a SCG bearer, then after the master node learns the information of the target secondary node, the master node sends a fourth notification to the core network, to make the core network transfer the transmission path of the SCG bearer to the target secondary node.

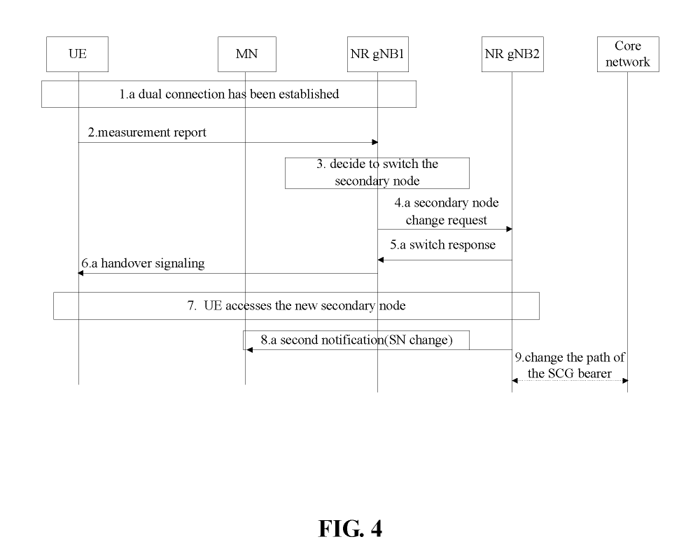

The secondary node changing process of this embodiment is described in detail with reference to FIG. 4. FIG. 4 schematically illustrates a signaling chart of a secondary node changing process according to an embodiment.

For the establishment of the dual connectivity state of the LTE system and the NR system, the process shown in FIG. 2 may be referred to. Assume that the master node (MN) belongs to the LTE system, and the secondary node (SN) belongs to the NR system. The master node requests the secondary node to configure a SCG parameter for the UE, and then transmits the parameter to the UE through a RRC signaling on the master node side, then the UE accesses the NR according to the RRC signaling, the dual connectivity is therefore implemented.

In this embodiment, in the dual connected state of the LTE-NR, the NR side can generate a RRC signaling of the NR side, and may transmit it directly to the UE, or transmit it to the UE through the master node. In order to maintain the independence of the two systems, the mobility of the NR side is implemented by the secondary node.

Referring to FIG. 4, the secondary node changing process may include the following steps:

Step 1: the UE has established a dual connectivity with the master node (MN) and the secondary node (gNB1). Wherein, gNB1 of the NR system serves as a secondary node, gNB2 is also a evolved node base station belongs to the NR system. The secondary node may configure a measurement for the frequency of the NR cell at which the UE is currently accessing for the UE.

Step 2: the UE reports the measurement report to the network. Specifically, the UE may send a measurement report directly to the gNB1, or the UE may report a measurement report to the master node first, then selected and forwarded the measurement report of the frequency at which the NR cell is to gNB1 by the master node. More specifically, when the UE sends the measurement report to gNB1, the UE may also measure some of the frequencies in the LTE system, and send a measurement report for the some of the frequencies to the master node.

Step 3: gNB1 makes decision based on the measurement report, and the cell load information of gNB2 sent from gNB2, and decides to switch the secondary node from gNB1 to gNB2.

Step 4: gNB1 sends a secondary node change request to gNB2. The secondary node change request may include a context information of the UE, such as a capability information of the UE, a bearer information established by the UE, and the like. For the SCG bearer of the UE, gNB1 needs to derive a new security key applied to gNB2, according to the key currently applied to the SCG bearer. The secondary node change request may carry the derived new security key, and the request and the key can be sent to gNB2 simultaneously.

More specifically, when deriving a new key applied for gNB2, other parameters such as a frequency information of the target cell charged by gNB2 may be introduced.

Step 5: after receiving the secondary node change request, gNB2 determines whether accept the secondary node change request or not according to the current cell load condition. If so, then gNB2 allocates necessary resources, such as a random access resource, configures necessary parameters, and sends a change response to gNB1 at the same time.

Step 6: gNB1 sends a handover signaling to the UE. The handover signaling may include resources gNB2 allocates for the UE. Alternatively, gNB1 may also send a handover signaling to the UE through the master node.

Simultaneously with step 6, gNB1 may also forward the downlink data that has not yet been sent to the UE to gNB2, so that gNB2 can immediately send the downlink data to the UE, after UE accesses gNB2.

Step 7: the UE accesses the new secondary node, i.e., gNB2, according to the handover signaling.

Step 8: after the UE accesses, gNB2 sends a second notification to the master node, to inform the master node that the secondary node changes. Specifically, after this step, a transmission channel for transmitting the split bearer data can be established between the gNB2 and the master node, so that the master node can transmit different split bearer data to the gNB2, and then sent to the UE by gNB2. For the uplink data of the split bearer, after receiving the data from the UE, the gNB2 needs to transmit the data to the master node through the transmission channel, the master node decrypts and sorts the data, in conjunction with the received split bearer data from the UE, then sends it to the core network.

Step 9: if the UE has established a SCG bearer, the gNB2 may notify the core network to switch the path of the SCG bearer to gNB2. For the downlink data carried by the SCG bearer, the core network can transfer the downlink data carried by the SCG bearer to gNB2 directly.

Alternatively, for step 8, which refers to informing to the master node that the secondary node changes, can also be performed after step 5, which refers to gNB1 sends the third notification to the master node.

Alternatively, other ways can be also used to implement step 9, when the master node learns that the secondary node has changed, the master node notifies the core network to modify the path of the SCG bearer to gNB2, so that the core network sends the downlink data of the SCG bearer to gNB2 directly.

In this embodiment, since the LTE and the NR belong to different systems, the master node of the LTE may not be able to well understand the load information of the NR-side cell, the interference information, and the like, passing the information of different systems between the LTE and NR system can lead to the two systems (the LTE system and the NR system) have a very high degree of coupling, which is not conducive to an independent evolution of the system. In this embodiment, the secondary node implements a secondary node switch within a same radio access technology (RAT), which can prevent the two systems from being highly coupled, and facilitate the independent evolution of the protocol. At the same time, can make the switch of the switch load on the NR side be more quick and convenient.

Those skilled in the art can understand that, to a case where the master node belongs to the NR system, the changing process of the secondary node can also refer to the procedure shown in FIG. 4. At this time, the evolved node base station in the LTE system acts as a secondary node for the UE, if the evolved node base station waiting to be switched also belongs to the LTE system, the switch of the secondary node can also be performed by the secondary node.

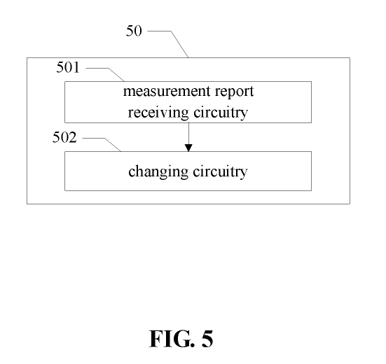

FIG. 5 schematically illustrates a diagram chart of an apparatus for secondary node changing according to an embodiment.

The apparatus for secondary node changing shown in FIG. 5 can include a measurement report receiving circuitry 501 and a changing circuitry 502.

Wherein, the measurement report receiving circuitry 501, may be configured to receive a measurement report of at least one frequency a user equipment does for, the user equipment is in a dual connectivity state, a system corresponding to the at least one frequency is different from a system to which a master node belongs.

The changing circuitry 502, can be configured to determine whether to switch a secondary node, according to the measurement report of the at least one frequency.

In some embodiments, if the system corresponding to the at least one frequency measured by the UE is different from the system to which the master node belongs, the measurement report receiving circuitry 501 may receive the measurement report for the at least one frequency the UE does for by the secondary node. Specifically, the secondary node may configure a measurement of certain frequencies in the system where the secondary node belongs to for the user equipment, for example, to configure the measurement for the frequency of the NR cell currently accessed by the UE.

It is understandable that, the measurement report may include an object measured by the user equipment, a cell list, a measurement result, and the like.

Preferably, the measurement report receiving circuitry 501 may receive the measurement report of at least one frequency an UE does for from the master node or the UE. In other words, the UE may send the measurement report of the at least one frequency to the secondary node directly; or the UE may send the measurement report of the at least one frequency to the master node, and then forward to the secondary node by the master node. Specifically, the master node may determine that the at least one frequency belongs to the system where the secondary node is located, so that the measurement report of the at least one frequency may be forwarded to the secondary node.

In some embodiments, after the secondary node obtains the measurement report of the at least one frequency, the changing circuitry 502 can at least determine whether to switch a secondary node, according to the measurement report of the at least one frequency. That is, the secondary node evaluates according to the measurement report, and then determines to switch the secondary node based on the evaluation result.

Compared with the master node determines whether to switch the secondary node recited in the existing technology, embodiments in this present disclosure, where the system corresponding to the at least one frequency is different from the system to which the master node belongs, the secondary node receives the measurement report for at least one frequency from the user equipment, and determines whether to switch the current secondary node, can select a better evolved node base station to provide service for the user equipment, thereby can improve efficiency of the data transmission, and can avoid improper secondary node switch resulted from the master node understands the information of the secondary node in different system improperly.

As for more contents about the work principle and the work mode of the apparatus for changing secondary node 50, reference may be referred to the related description in FIG. 3 to FIG. 4, therefore details are not described hereinafter.

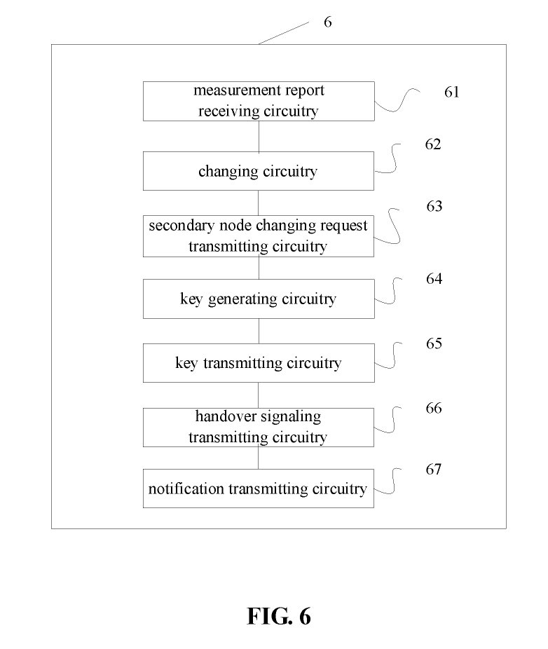

FIG. 6 schematically illustrates a diagram chart of an apparatus for changing secondary node according to another embodiment.

The apparatus for changing secondary node 6 shown in FIG. 6 may include a measurement report receiving circuitry 61 and a changing circuitry 62.

Wherein, the measurement report receiving circuitry 61, can be configured to receive a measurement report of at least one frequency a user equipment does for, the user equipment is in a dual connectivity state, a system corresponding to the at least one frequency is different from a system to which a master node belongs; the changing circuitry 62, can be configured to determine whether to switch a secondary node, according to the measurement report of the at least one frequency.

Preferably, the changing circuitry 62, can be configured to determine whether to switch the secondary node, according to the measurement report of the at least one frequency, and a cell load information of the cells included in the measurement report.

Preferably, the apparatus for changing secondary node 6 can further include a secondary node change request transmitting circuitry 63, the secondary node change request transmitting circuitry 63 can be configured to: transmit a secondary node change request to a target secondary node, when determining to switch a current secondary node, to make the target secondary node determine whether to accept the secondary node change request or not, based on the cell load information after receiving the secondary node change request. Further, the secondary node change request can include split bearer and/or SCG bearer information of the user equipment.

Preferably, the apparatus for changing secondary node 6 can include a key generating circuitry 64 and a key transmitting circuitry 65, the key generating circuitry 64 can be configured to generate a new security key to use for the target secondary node, according to a current security key of a SCG bearer when determining to switch the secondary node, if the user equipment is configured with the SCG bearer; the key transmitting circuitry 65 can be configured to transmit the new security key together within the secondary node change request.

Preferably, the apparatus for changing secondary node 6 can further include a handover signaling transmitting circuitry 66, the handover signaling transmitting circuitry 66 can be configured to transmit a handover signaling to the user equipment, after receiving a secondary node changing response transmitted by the target secondary node, so that the user equipment accesses the target secondary node according to the handover signaling.

Preferably, if the user equipment is configured with a SCG bearer, the target secondary node sends a first notification to a core network, so that the core network switches a transport path of the SCG bearer to the target secondary node.

Preferably, the target secondary node transmits a second notification to the master node, after the user equipment accesses the target secondary node, so that the master node learns information of the target secondary node.

Preferably, the apparatus for changing secondary node 6 can further include a 67, the notification transmitting circuitry 67 can be configured to transmit a third notification to the master node, after receiving the secondary node changing response transmitted by the target secondary node, so that the master node learns information of the target secondary node.

Preferably, if the user equipment is configured with a split bearer, the master node establishes a transmission channel between the master node and the target secondary node, after the master node learns information of the target secondary node, to transmit a split bearer data.

Preferably, if the UE is configured with a SCG bearer, then after the master node learns the information of the target secondary node, the master node sends a fourth notification to the core network, to make the core network transfers the transmission path of the transfer bearer to the target secondary node.

As for more contents about the work principle and the work mode of the apparatus for changing secondary node 6, reference may be referred to the related description in FIG. 3 to FIG. 5, and detailed description is not provided herein after.

Embodiment of this disclosure also discloses a evolved node base station, the evolved node base station may include the apparatus for changing secondary node 50 shown in FIG. 5 or the apparatus for changing secondary node 6 shown in FIG. 6. The apparatus for changing secondary node may be internally integrated or externally coupled to the evolved node base station.

Those skilled in the art can understand that all or a portion of the various methods of the various embodiments described above may be implemented by a program commands an associated hardware, which may be stored in a computer readable storage medium, which may include: ROM, RAM, disk or optical disk and the like.

Although the present disclosure has been disclosed above with reference to preferred embodiments thereof, it should be understood that the disclosure is presented by way of example only, and not limitation. Those skilled in the art can modify and vary the embodiments without departing from the spirit and scope of the present disclosure.

What is claimed is:

1. A method for changing secondary node, applied in a secondary node, comprising:
receiving a measurement report of at least one frequency of a user equipment, the user equipment being in a dual connectivity state, a system corresponding to the at least one frequency being different from a system to which a master node belongs; and
determining whether to change a secondary node, according to the measurement report of the at least one frequency.

2. The method according to claim 1, wherein determining whether to change a secondary node, according to the measurement report of the at least one frequency, comprises:
determining whether to change the secondary node, according to the measurement report of the at least one frequency, and cell load information of cells included in the measurement report.

3. The method according to claim 1, further comprising:
transmitting a secondary node change request to a target secondary node, when determining to switch a current secondary node, so that the target secondary node determines whether to accept the secondary node change request or not, based on the cell load information, after receiving the secondary node change request.

4. The method according to claim 3, further comprising:
generating a new security key to use for the target secondary node, according to a current security key of a SCG bearer, when determining to switch the secondary node, if the user equipment is configured with the SCG bearer; and
transmitting the new security key together with the secondary node change request.

5. The method according to claim 3, further comprising:
transmitting a handover signaling to the user equipment, after receiving a secondary node changing response transmitted by the target secondary node, so that the user equipment accesses the target secondary node according to the handover signaling.

6. The method according to claim 5, wherein if the user equipment is configured with a SCG bearer, the target secondary node sends a first notification to a core network, so that the core network switches a transport path of the SCG bearer to the target secondary node.

7. The method according to claim 5, wherein after the user equipment accesses the target secondary node, the target secondary node transmits a second notification to the master node, so that the master node learns information of the target secondary node.

8. The method according to claim 3, further comprising:
transmitting a third notification to the master node, after receiving the secondary node change response transmitted by the target secondary node, so that the master node learns information of the target secondary node.

9. The method according to claim 7, wherein if the user equipment is configured with a split bearer, the master node establishes a transmission tunnel between the master node and the target secondary node, after the master node learns information of the target secondary node, to transmit split bearer data.

10. The method according to claim 3, wherein the secondary node change request comprises:
split bearer and/or SCG bearer information of the user equipment.

11. The method according to claim 1, wherein receiving a measurement report of at least one frequency of a user equipment, comprises:
receiving the measurement report of at least one frequency of a user equipment from the master node or the user equipment, wherein the measurement report of the at least one frequency is generated by the user equipment according to measurement configuration from the secondary node.

12. An apparatus for changing secondary node, applied in a secondary node, comprising:
a measurement report receiving circuitry, configured to receive a measurement report of at least one frequency a user equipment does for, the user equipment being in a dual connectivity state, a system corresponding to the at least one frequency being different from a system to which a master node belongs; and
a changing circuitry, configured to determine whether to change a secondary node, according to the measurement report of the at least one frequency.

13. The apparatus according to claim 12, wherein the changing circuitry is configured to:
determine whether to switch the secondary node, according to the measurement report of the at least one frequency, and a cell load information of the cells included in the measurement report.

14. The apparatus according to claim 12, further comprising:
a secondary node change request transmitting circuitry, configured to: transmit a secondary node change request to a target secondary node, when determining to switch a current secondary node, so that the target secondary node determines whether to accept the secondary node change request or not, based on the cell load information after receiving the secondary node change request.

15. The apparatus according to claim 14, further comprising:
a key generating circuitry, configured to generate a new key to use for the target secondary node, according to a current security key of a SCG bearer when determining to switch the secondary node, if the user equipment is configured with the SCG bearer; and
a key transmitting circuitry, configured to transmit the new security key together with the secondary node change request.

16. The apparatus according to claim 14, further comprising:
a handover signaling transmitting circuitry, configured to transmit a handover signaling to the user equipment, after receiving a secondary node change response transmitted by the target secondary node, so that the user equipment accesses the target secondary node according to the handover signaling.

17. The apparatus according to claim 16, wherein if the user equipment is configured with a SCG bearer, the target secondary node sends a first notification to a core network, so that the core network switches a transport path of the SCG bearer to the target secondary node.

18. The apparatus according to claim 16, wherein after the user equipment accesses the target secondary node, the target secondary node transmits a second notification to the master node, so that the master node learns information of the target secondary node.

19. The apparatus according to claim 14, further comprising:
a notification transmitting circuitry, configured to transmit a third notification to the master node, after receiving the secondary node change response transmitted by the target secondary node, so that the master node learns information of the target secondary node.

20. The apparatus according to claim 18, wherein if the user equipment is configured with a split bearer, the master node establishes a transmission channel between the master node and the target secondary node, after the master node learns information of the target secondary node, to transmit a split bearer data.

21. The apparatus according to claim 14, wherein the secondary node change request comprises: split bearer and/or SCG bearer information of the user equipment.

22. The apparatus according to claim 12, wherein the measurement report receiving circuitry, is configured to: receive the measurement report of at least one frequency of a user equipment from the master node or the user equipment, wherein the measurement report of the at least one frequency is generated by the user equipment according to measurement configuration from the secondary node.

23. A base station, comprising an apparatus for changing secondary node recited in claim 12.
